(19) United States
(12) Patent Application Publication
(10) Pub. No.: US 2010/0313611 A1
(43) Pub. Date: Dec. 16, 2010

(54) Stringed instrument locking device

(76) Inventor: Christopher T. Goulet, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 12/658,289

(22) Filed: Feb. 9, 2010

Related U.S. Application Data
(60) Provisional application No. 61/268,366, filed on Jun. 11, 2009.

(51) Int. Cl. E05B 73/00; E05B 65/00

(52) U.S. Cl. 70/58

(57) ABSTRACT

A locking device is described for preventing the theft of a stringed instrument having a neck with a curved rear face and a planar front face. The locking device includes a rear arm having a curved inner face corresponding to the rear face of the neck, and a front arm having a planar inner face corresponding to the front face of the neck. The arms are hinged at their proximal ends so that the front arm is pivotal toward and away from the rear arm. Spaced axially aligned rows of padding projections extend inwardly from the inner faces of the arms. A lock releasibly joins the distal ends of the arms to lock the locking device around the neck of an instrument. A cable has a proximal end attachable in a groove between the hinged ends of the arms and a distal end attachable to a stationary object.

This application claims the benefit of the filing date of U.S. Provisional Application Ser. No. 61/268,366, filed Jun. 11, 2009, and entitled Guitar Locking Device, the entire contents of which-are incorporated herein by reference.

### BACKGROUND OF THE INVENTION

(1) Field of the Invention

The present invention relates generally to a device for preventing the theft of a stringed instrument having a neck, and in particular to a lock that can be attached around the neck of a guitar and also attached to a stationary object to prevent theft of the guitar.

(2) Description of the Prior Art

Quality guitars and similar instruments are often of considerable value and are easily transportable, making them tempting targets for theft. To address this concern, the prior art has attempted to devise locking devices that would prevent, or at least deter, the theft of these instruments by securing the instruments to a stationary object.

For example, U.S. Pat. No. 6,164,097 to McBryde, entitled “Portable Locking Device For Protection of Stringed instruments”, describes a locking device for removable attachment around the neck of a guitar. The McBryde device is comprised of first and second rigid arm members, each having a curved portion and a straight portion. The arm members are mirror images of each other. Mating eye members are attached to each of the curved portions, and mating hinge members are attached to each of the straight portions. The inner surfaces of the members are padded with a soft resilient material.

When the McBryde device is used, the hinge is pivoted to an open position and the guitar neck is inserted into the device. The hinge is then pivoted to the closed position so that the straight portions are aligned across the front of the neck and the curved portions wrap around the neck to join the mating eye members. A cable can then be inserted through the mating eye member and attached to a fixed structure.

While the principal of the McBryde device is sound, the structure has at least two deficiencies. First, when the device is properly sized to fit tightly around the instrument neck, closing of the device onto the neck causes the inner pads on the straight sections of the arms to rub against the instrument strings, causing wear to the pads and potential catching of the strings on the pads as the device is closed. In addition, the pads on the curved portions rub against the high-gloss rear of the neck, potentially damaging the finish.

Second, the device is held in a closed configuration around the guitar neck due to the cable that extends through the mating eye members at the ends of the curved portions. Therefore, when it is desired to move the instrument from one location to another, it is necessary to remove the locking device from the neck and replace it again when attaching the device to a stationary object.

Thus, there is still a need for a removable lock that can be attached around the neck of a guitar or other stringed instrument having a neck, e.g., a violin, banjo, etc., and in particular a lock that can be attached without potential damage to the instrument, with the lock remaining attached when the instrument is not attached to a stationary object. These objects and others are achieved by the guitar lock described herein, it being understood that the term “guitar lock” is not intended to limit the use of the lock to guitars only, recognizing that the lock also has utility in the protection of other stringed instruments from theft.

### SUMMARY OF THE INVENTION

Generally, the guitar lock of the present invention is configured for attachment around a stringed instrument neck having a generally planar front side and a curved rear side. The present lock is comprised of a continuous rear arm having a proximal end, a distal end, and a curved inner face having a curvature corresponding to the curvature of the rear side of the instrument neck; and a continuous front arm having a proximal end, a distal end, and a generally planar inner face toward the curved inner face of the rear arm.

The front arm inner face corresponds to the front side of the instrument neck. The front and rear arm inner faces, when the lock is closed, define a neck receiving opening having a cross-section corresponding to the cross-section of the instrument neck.

The outer face of the rear arm is preferably convexly curved to correspond to the curvature of the rear arm inner face, while the outer face of the front arm is preferably planar and parallel to the front arm inner face, resulting in reduced manufacturing costs and improved appearance. The front arm outer face may also include a distinct area for addition of indicia, such as the devices' trademark or a logo.

The rear and front arms are hinged at their proximal ends on one side of the neck receiving opening, and are releasibly locked by a locking member joining the distal ends of the rear and front arms opposite from the hinge. The hinge and neck receiving space are preferably axially aligned with each other. Resilient padding is secured to the inner faces of the rear and front arms. A cable attachment means is integral with one of the arms or may be in the form of a recess between the rear and front arm at the hinge within which an end of the cable is clamped.

The arms may be formed of a one piece material, e.g., molded of an engineering plastic, or maybe formed with a solid core of metal or plastic that is overmolded with a resilient plastic or rubber-like material. The pads may be integral with the arms, or releasibly attached for ease of replacement.

Preferably, the hinge is comprised of intermeshing fingers with aligned cylindrical bores at the proximal ends of the rear and front arms, and a cylindrical hinge pin inserted through the aligned bores to hold the fingers in intermeshed position. The distal ends have incorporated therein a locking member to releasibly hold the ends together when the lock is secured around the guitar neck. The locking member may be a cylinder lock having retracted and inserted positions, or other suitable locking member, including an electronic locking member.

In order to attach the locking device around the neck of a guitar or other stringed instrument, the device is opened by pivoting the front arm away from the rear arm at the hinge. The rear of the neck of the guitar is then positioned against the pads on the inner face of the rear arm. The front arm is then pivoted onto the front of the guitar neck and the locking member is engaged. Note that rubbing of the guitar neck against the rear arm does not occur. Further, the pads on the inner face of the front arm only press against the front face of the neck between the instrument strings running axially along the front of the neck front face, again without any rubbing or lateral movement.

In one embodiment, after the locking device has been placed around the guitar neck, a flexible locking cable, similar to a bicycle locking cable, can be inserted through the cable opening integral with one of the arms, preferably the rear arm. The cable is then looped around a stationary object and locked, thereby securing the guitar to the stationary object.

Alternatively, in a second embodiment, when the locking device is open, an end of the cable is inserted in a recess formed of mating grooves in the front and rear arm inner faces adjacent the hinge. Closing of the locking device clamps the cable end securely between the rear and front arms preventing detachment of the cable as long as the locking device is closed.

When the owner desires to move the guitar to another location, the cable can be unlocked, with or without removing the cable from the locking device. If the guitar is not to be played, the guitar, with the locking device still in place, can then be moved to a different location and attached to a different stationary object.

The front arm of the locking device is one continuous arm that extends entirely across the front of the neck from the hinge on one side to the locking member on the other side. As a result, a continuous outer front face is provided for inclusion of a product name, owner's name, decoration, etc.

The locking device arms can be made of various materials, such as metal or engineering plastic, the only requirement being that the arms should be cut and break resistant, so that the lock is not easily broken by a thief trying to detach the locking device from the guitar neck.

### BRIEF DESCRIPTION OF THE DRAWINGS

FIG. 1 is a perspective view of a first embodiment of the guitar locking device.

FIG. 2 is an end view of the first embodiment.

FIG. 3 is a top view of the embodiment.

FIG. 4 is a perspective view of a second embodiment of the guitar locking device locked around a part of a guitar neck.

FIG. 5 is a perspective view of the second embodiment opened and around a part of a guitar neck.

FIG. 6 is a perspective view of the second embodiment opened.

FIG. 7 is a perspective view of the second embodiment locked.

FIG. 8 is a side view of the second embodiment locked.

FIG. 9 is a perspective rear view of the second embodiment with an attached locking cable.

FIG. 10 is a perspective bottom view of the second embodiment with an attached locking cable.

FIG. 11 is a perspective view of the locking cable. FIGS. 12-14 illustrate an alternative locking device with a pad that includes a plurality of resilient, truncated pyramid shaped pad projections and instrument string muting webs.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

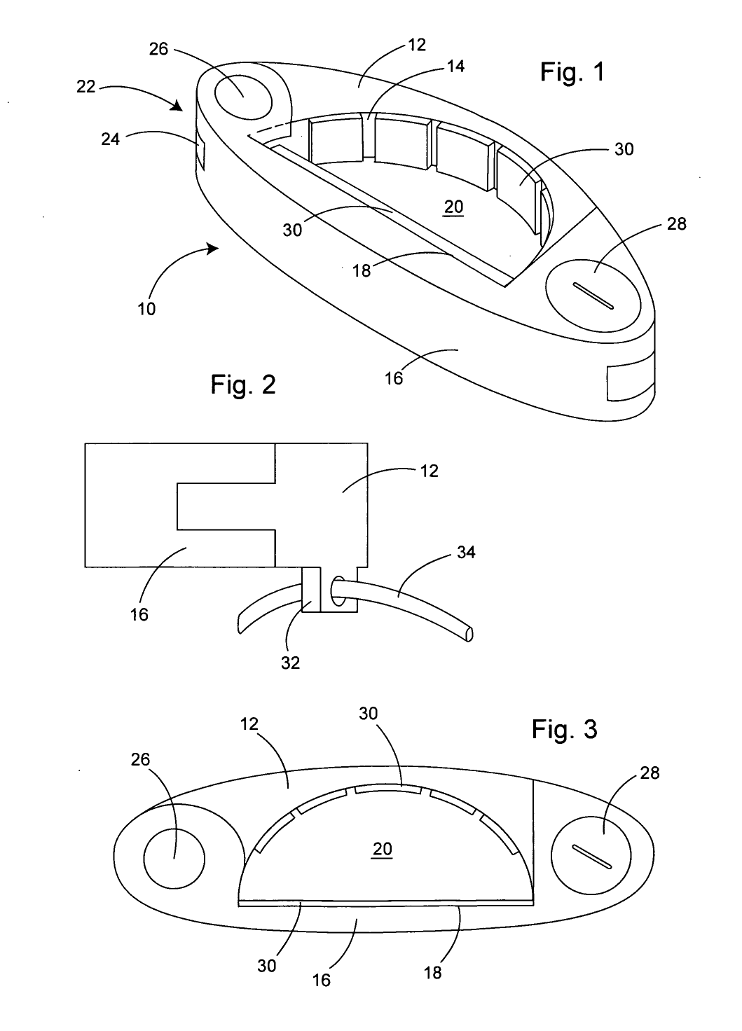

As illustrated in FIGS. 1-3, guitar lock, generally 10, is comprised of continuous rear arm 12 having a proximal end, a distal end, and a curved inner face 14, which has a curvature corresponding to the curvature of the rear side of the guitar neck; and a continuous front arm 16 having a proximal end, a distal end, and a generally planar inner face 18 facing toward inner face 14 of rear arm 12. When locking device 10 is closed, inner faces 14 and 18 define a neck receiving opening 20 that has a cross-section corresponding to the cross-section of neck of the instrument being protected.

Rear arm 12 and front arm 16 are hinged at their proximal ends on one side of the neck receiving opening 20 by hinge, generally 22, which is comprised of interlocking fingers 24 of arms 12 and 16, and hinge pin 26 inserted through mating cylindrical bores in fingers 24.

Locking device 10 is releasibly locked about an instrument neck by locking member 28, which joins the distal ends of rear arm 12 and front arm 16 at the side of the neck receiving opening 20 opposite from hinge 22. Hinge 22, neck receiving opening 20 and locking member 28 are axially aligned in the preferred embodiment shown. Resilient pads 30 are secured to the inner faces of the rear and front arms.

Cable attachment means 32, shown in the illustrated embodiment as a bore through a projection integral with the bottom of rear arm 12, is used to insert flexible cable 34, which can be looped around a stationary object, not shown. It will be understood that the projection may extend from other areas of rear arm 12 or from front arm 16, or can be of another configuration, so long as it is capable of securely attaching cable 34.

Locking device 10 is placed around the neck of a guitar by pivoting front arm 16 away from rear arm 12 at hinge 22. The neck of the guitar is then positioned against the rear pads 30 on the inner face 14 of rear arm 12. Front arm 16 is then pivoted onto the front of the guitar neck and locking member 28 is engaged. Cable 34 is inserted through the bore of cable attachment means 32 and looped and locked around a stationary object to secure the guitar to the stationary object.

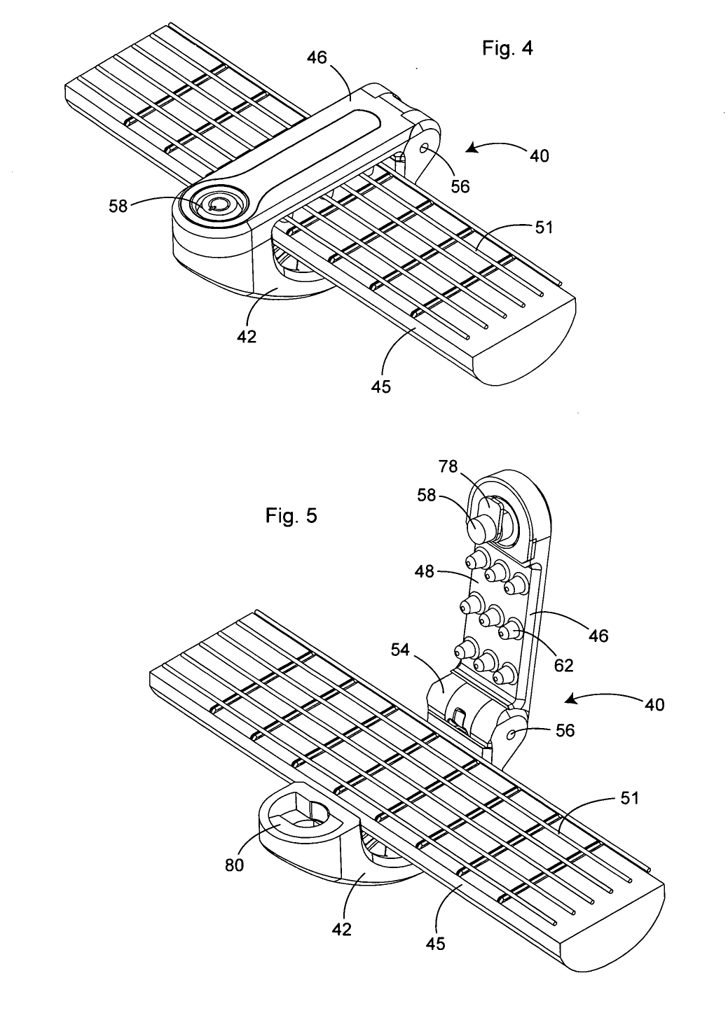

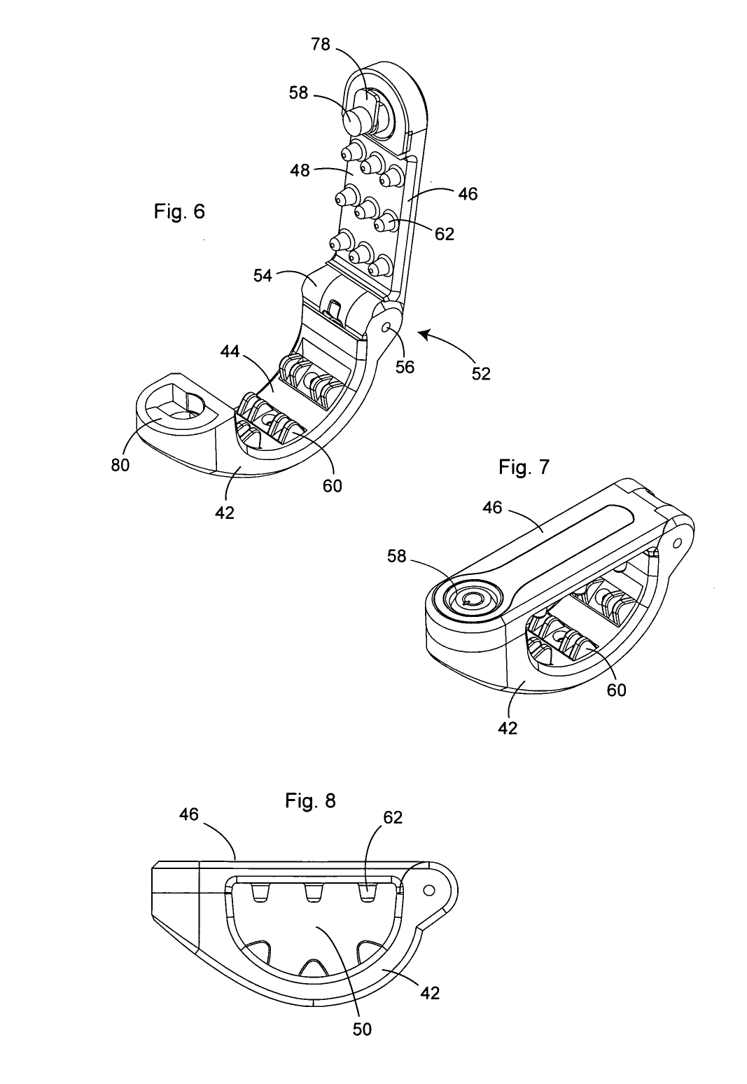

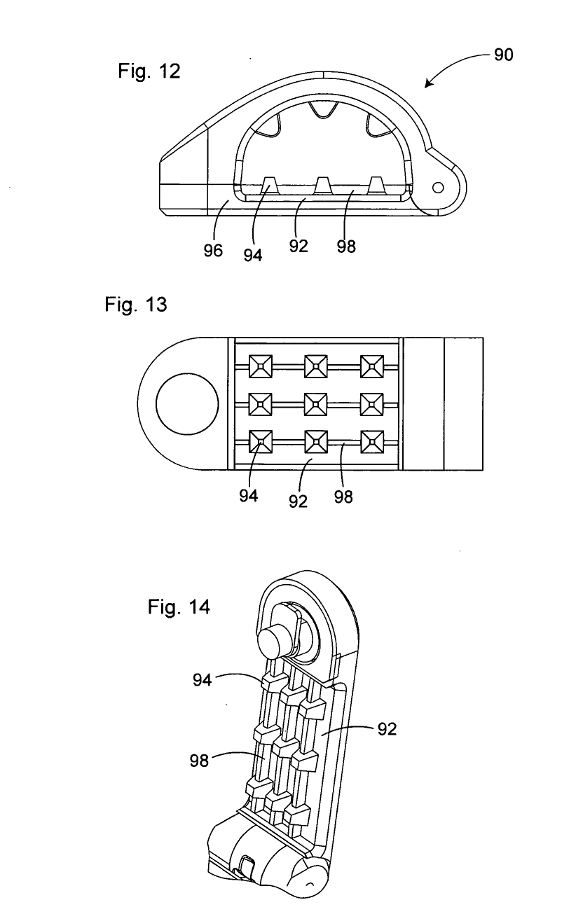

As illustrated in FIGS. 4-11, an alternative design for a guitar lock, generally 40, is comprised of continuous rear arm 42 having a proximal end, a distal end, and a curved inner face 44, which has a curvature corresponding to the curvature of the rear side of guitar neck 45; and a continuous front arm 46 having a proximal end, a distal end, and a generally planar inner face 48 facing toward inner face 44 of rear arm 42. When locking device 40 is closed as shown in FIGS. 4, 7, 8, 9 and 10, inner faces 44 and 48 define a neck receiving opening 50 that has a cross-section corresponding to the cross-section of neck 45.

Rear arm 42 and front arm 46 are hinged at their proximal ends on one side of the neck receiving opening 50 by hinge, generally 52, which is comprised of interlocking fingers 54 of arms 42 and 46, and hinge pin 56 inserted through mating cylindrical bores in fingers 54.

Locking device 40 is releasibly locked about an instrument neck by locking member 58, which joins the distal ends of rear arm 42 and front arm 46 at the side of the neck receiving opening 50 opposite from hinge 52. Hinge 52 and neck receiving opening 50 are axially aligned, with locking member 58 being transverse to hinge 52 and opening 50.

Lower arm 42 includes a plurality of triangular resilient pads 60 axially aligned across inner face 44 of arm 42 in a plurality of spaced rows. Each inwardly projecting pad 60 has a width greater than its thickness so that the pads are axially flexing. As a result, placement of locking device 40 onto neck 45 is possible without damage to the finish of neck 45. Planar inner face 48 of arm 46 includes a plurality of resilient flexible pads 50 spaced to engage the front of neck 45 between strings 51 when locking device 40 is in the closed position. Preferably, pads are generally conical and are arranged in a plurality of axially aligned spaced rows for insertion between strings 51.

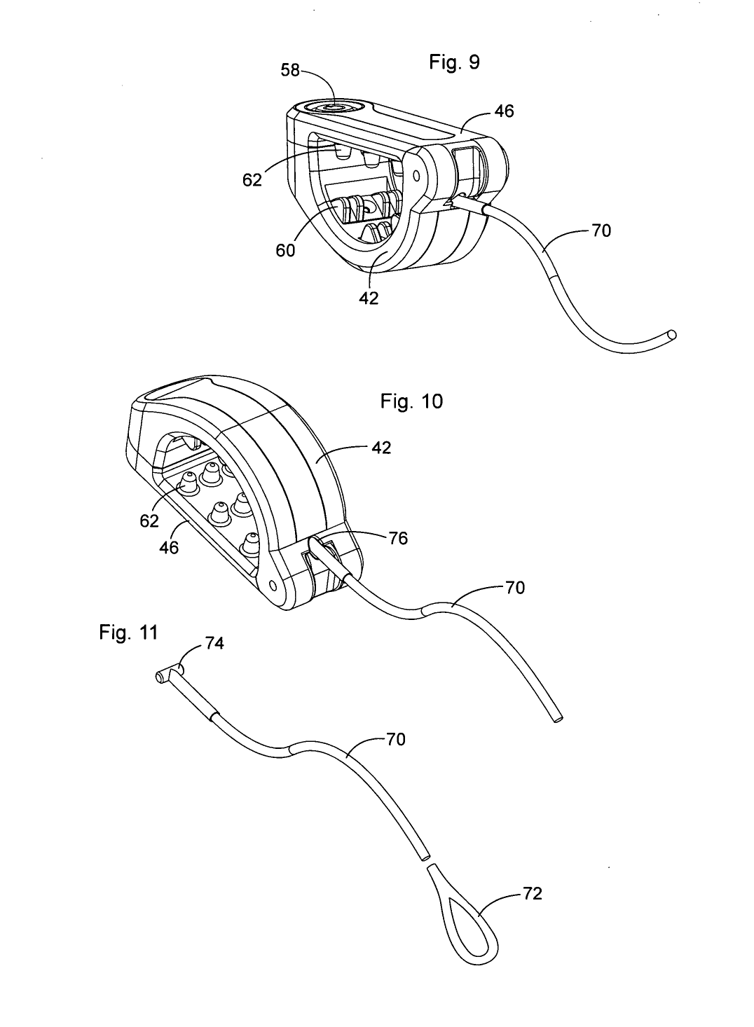

As illustrated in FIGS. 9-11, locking device 40 preferably also includes a cable 70 that includes a proximal end for attachment between arms 42 and 46, and a distal end that can be attached around a stationary object to secure the guitar to the stationary object. The distal end can be of various configurations depending on the manner of attachment. For example, the distal end of cable 70 can include a loop 72, with cable 70 being looped around the stationary object with the proximal end of cable 70 being extended through loop 72 before attachment to locking device 70.

In order to attach cable 70 between arms 42 and 46, the proximal end of cable 70 preferably includes an enlarged head, shown in the drawings as T-shaped head 74. The inner faces of arms 42 and 46 include recesses at their hinged ends which together form a cable receiving groove 76 sized to correspond to the cross-section of cable 70, but smaller than head 74.

To prevent theft of a guitar or other stringed instruments, cable 70 is attached at its distal end to a stationary structure, not shown, and the proximal end of cable 70 is inserted between the hinged ends of arms 42 and 46. Rear arm 42 is then placed against the rear of neck 51 with pads 60 serving to protect the finish of neck 51. Front arm 46 is then pivoted at hinge 52 to close the distal ends of arms 42 and 46 together. When closed, pads 62 press against neck 50 between strings 51. Cam 78 of lock 58 is then rotated to a locked position beneath flange 80 by a key, not shown. When in the locked position, cable 70 fits snugly within groove 76, with head 74 preventing removal of cable 70. Thus, the guitar is securely attached to the stationary member until locking device 40 is unlocked.

FIGS. 12-14 illustrate an alternative locking device, generally 90, with a pad 92, shown as a replaceable pad, that includes a plurality of resilient, truncated pyramid shaped pad projections 94 axially aligned across arm 96 in a plurality of spaced rows.

Webs 98 extend longitudinally of the arm between adjacent pad projections 94. Webs 98 are approximately one-third to about one-half of the height of projections 94 and serve to mute the instrument strings when the lock is in place. When locked, projections 94 are positioned between the strings, while the strings are pressed lightly by webs 98.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A locking device attachable around a stringed instrument neck having a curved rear face and a planar front face comprising:
a) a rear arm having a curved inner face corresponding to the rear face of the neck, a rear arm proximal end and a rear arm distal end;
b) a front arm having a planar inner face corresponding to the front face of the neck, a front arm proximal end hinged to the rear arm proximal end whereby the front arm is pivotal toward and away from the rear arm, and a front arm distal end; and
c) a locking member at the front arm distal end attachable to the rear arm distal end to secure the front and rear arms in the closed position.

2. The locking device of claim 1, wherein the rear arm inner face includes pads engaging the neck rear face.

3. The locking device of claim 1, wherein the front arm inner face includes pads engaging the neck front face.

4. The locking device of claim 1, wherein the locking member is a cam lock mounted perpendicular to the front arm, the cam lock having a cam rotatable in a recess in the distal end of the rear arm.

5. The locking device of claim 1, further including a cable having a proximal end attachable to the locking device and a distal end attachable to a stationary object.

6. The locking device of claim 1, wherein the proximal ends of the front and rear arms include intermeshing fingers, the locking device further including a hinge pin inserted through the fingers.

7. The locking device of claim 1, wherein the rear arm has a curved outer face.

8. The locking device of claim 1, wherein the front arm has a planar outer face.

9. A locking device attachable around a stringed instrument neck having a curved rear face and a planar front face comprising:
a) a rear arm having a curved, padded inner face corresponding to the rear face of the neck, a rear arm proximal end and a rear arm distal end;
b) a front arm having a planar, padded inner face corresponding to the front face of the neck, a front arm proximal end hinged to the rear arm proximal end whereby the front arm is pivotal toward and away from the rear arm, and a front arm distal end;
c) a locking member at the front arm distal end releasibly attachable to the rear arm distal end to secure the front and rear arms in the closed position; and
d) a cable having a proximal end attachable between the proximal ends of the front and rear arms, and a distal end attachable to a stationary object.

10. The locking device of claim 9, wherein the rear arm inner face pad includes spaced projections engaging the neck rear face.

11. The locking device of claim 9, wherein the front arm inner face pad includes spaced projections engaging the neck front face between the strings of the instrument and webs extending between the projections to engage the strings.

12. The locking device of claim 9, wherein the locking member is a cam lock mounted perpendicular to the front arm, the cam lock having a cam rotatable in a recess in the distal end of the rear arm.

13. The locking device of claim 9, further including a cable having a loop at its distal end, the cable proximal end being insertable through the loop.

14. The locking device of claim 9, wherein the proximal ends of the front and rear arms include intermeshing fingers, the locking device further including a hinge pin inserted through the fingers.

15. The locking device of claim 9, wherein the rear arm has a curved outer face.

16. The locking device of claim 9, wherein the front arm has a planar outer face.

17. A locking device attachable around a stringed instrument neck having a curved rear face and a planar front face comprising:
a) a rear arm having a curved inner face corresponding to the rear face of the neck, a rear arm proximal end and a rear arm distal end;
b) a front arm having a planar inner face corresponding to the front face of the neck, a front arm proximal end hinged to the rear arm proximal end whereby the front arm is pivotal toward and away from the rear arm, and a front arm distal end;
c) spaced axially aligned rows of rear arm padding projections extending inwardly from the rear arm inner face;
d) spaced axially aligned rows of front arm padding projections extending inwardly from the front arm inner face;
e) a locking member at the front arm distal end attachable to the rear arm distal end to secure the front and rear arms in the closed position; and
f) a cable having a proximal end attachable in a groove between the proximal ends of the front and rear arms, and a distal end attachable to a stationary object.

18. The locking device of claim 17, wherein the rear arm projections are triangular with a width greater than their thickness.

19. The locking device of claim 17, wherein the front arm projections are conical.

20. The locking device of claim 17, wherein the cable distal end is looped.
